(19) United States
(12) Patent Application Publication
(10) Pub. No.: US 2012/0242528 A1
(43) Pub. Date: Sep. 27, 2012

(54) RECEIVING APPARATUS AND RECEIVING METHOD

(75) Inventor: Takeshi SATO, Tokyo (JP)

(73) Assignee: NEC Corporation, Tokyo (JP)

(21) Appl. No.: 13/421,752

(22) Filed: Mar. 15, 2012

(30) Foreign Application Priority Data
Mar. 23, 2011 (JP) 64548/2011

(51) Int. Cl. G01S 13/91; H04L 27/06

(52) U.S. Cl. 342/37; 375/341

(57) ABSTRACT

A receiving apparatus for receiving a pulse sequence signal includes a pulse decoding unit which determines, by observing, about a detection signal obtained by performing synchronous detection of a pulse sequence signal modulated by at least a pulse position modulation method, the pulse sequence signal as a pulse string transmitted by on-off keying, and applying a maximum likelihood sequence estimation method using trellis state transition defined by a time interval of the on-off keying and an on-off value concerned, an on-off value of the received pulse string, and a data decoding unit which decode, about the pulse string, information data transmitted by the pulse position modulation method.

This application is based upon and claims the benefit of priority from Japanese Patent Application No. 2011-064548, filed on Mar. 23, 2011, the disclosure of which is incorporated herein in its entirety by reference.

### TECHNICAL FIELD

The present invention relates to a receiving apparatus and a receiving method for receiving a pulse sequence signal transmitted using a pulse position modulation method.

### BACKGROUND ART

Secondary Surveillance Radar (SSR) mode S sends and receives data between a transponder mounted onto a flying object and a receiving station on one-to-one basis. A signal used here includes various interrogation signals, response signals and extended squitter signals. Meanwhile, an extended squitter signal is a signal for broadcasting information on a position and a speed of an airframe and information on a transponder by a random access method.

Because of a characteristic that an extended squitter signal is used by a random access method, it becomes asynchronous interference to mode S signals transmitted by other air planes.

In document 1, as a solution technology when the asynchronous interference is caused, there is disclosed a method to determine a numerical value of a pulse by presuming an overlap of pulses from an envelope of a received signal. Also, there is disclosed a method to separate pulses based on a frequency error between signals transmitted by carrier waves of an identical frequency from different transmission sources. Also disclosed is a technology which judges that a pulse is ON (‘1’ as a numerical value of a bit) or OFF (‘0’ as a numerical value of a bit) according to the level of the pulse by detecting a rising edge based on a difference between amplitudes.

In a method according to document 2, there is disclosed a technology for separating pulses by improving the estimation accuracy of an arrival direction of a signal using array signal processing.
(Document 1) ANALYSIS OF SSR SIGNALS BY SUPER RESOLUTION ALGORITHMS, GASPARE GALATI, SIMONE BARTOLINI, LUCA MENE; SIGNAL PROCESSING AND INFORMATION TECHNOLOGY, 2004. PROCEEDINGS OF THE FOURTH IEEE INTERNATIONAL SYMPOSIUM
(Document 2) 1090 MHZ CHANNEL CAPACITY IMPROVEMENT IN THE AIR TRAFFIC CONTROL CONTEXT, G. GLALATI, E. G. PIRACCI, N. PETROCHILOS, F. FIORI; PROCEEDINGS OF ESAV' 08-SEPTEMVER 3-5-CAPRI, ITALY

However, in the method according to an envelope of a received signal of document 1, because there are many thresholds and condition judgment procedures, there is a problem that processing becomes complicated. Also, in the method to focus attention on a difference between frequencies, there is a problem that a large effect is not obtained when there is not a large difference in carrier frequencies of respective pulses.

In the method according to document 2, because a plurality of array elements are needed and calculation of propagation path information between a transmission source and each array is needed, there is a problem that processing and an apparatus becomes complicated. Also in the method according to document 2, there is a problem that it cannot handle interference beyond a resolution.

### SUMMARY

In order to settle the above-mentioned problem, an object of the present invention is to provide, by an easy structure and an easy processing method, a receiving apparatus and a receiving method which solve interference occurring when a plurality of transmission sources transmit signals by a random access method using an identical pulse position modulation method.

A receiving apparatus for receiving a pulse sequence signal includes a pulse decoding unit which determines, by observing, about a detection signal obtained by performing synchronous detection of a pulse sequence signal modulated by at least a pulse position modulation method, the pulse sequence signal as a pulse string transmitted by on-off keying, and applying a maximum likelihood sequence estimation method using trellis state transition defined by a time interval of the on-off keying and an on-off value concerned, an on-off value of the received pulse string, and a data decoding unit which decode, about the pulse string, information data transmitted by the pulse position modulation method.

A receiving method for receiving a pulse sequence signal includes a pulse decoding procedure for determining, by observing, about a detection signal obtained by performing synchronous detection of a pulse sequence signal modulated by at least a pulse position modulation method, the pulse sequence signal as a pulse string transmitted by on-off keying, and applying a maximum likelihood sequence estimation method using trellis state transition defined by a time interval of the on-off keying and an on-off value concerned, an on-off value of the received pulse string, and a data decoding procedure for decoding, about the pulse string, information data transmitted by said pulse position modulation method.

### BRIEF DESCRIPTION OF THE DRAWINGS

Exemplary features and advantages of the present invention will become apparent from the following detailed description when taken with the accompanying drawings in which:

FIG. 1, a block diagram of a receiving apparatus according to a first exemplary embodiment of the present invention;

FIG. 2, a detailed block diagram of a sampling circuit according to the first exemplary embodiment;

FIG. 3, a detailed block diagram of a preamble circuit according to the first exemplary embodiment;

FIG. 4 is a detailed block diagram of a propagation path information generating circuit according to the first exemplary embodiment;

FIG. 5 is a detailed block diagram of a decoder circuit according to the first exemplary embodiment;

FIG. 6(a) is a timing chart of a format of SSR mode according to the first exemplary embodiment;

FIG. 6(b) is a timing chart of a data decode string as an example of data transfer according to the first exemplary embodiment;

FIG. 6(c) is a timing chart of a pulse decode string when seen as on-off keying according to the first exemplary embodiment;

FIG. 7(a) is a timing chart of a pulse sequence according to the first exemplary embodiment;

FIG. 7(b) is a timing chart of another pulse sequence according to the first exemplary embodiment;

FIG. 7(c) is a start timing chart of a correlation part in a sampling circuit according to the first exemplary embodiment;

FIG. 7(d) is a start timing chart in a counter in a sampling circuit according to the first exemplary embodiment;

FIG. 7(e) is a start timing chart in a preamble synchronizing circuit according to the first exemplary embodiment;

FIG. 7(f) is a start timing chart of a sample value memory circuit according to the first exemplary embodiment;

FIG. 8(a) is an arrival timing chart of three pulse sequences according to the first exemplary embodiment;

FIG. 8(b) is an operation timing chart of a sample value memory circuit according to the first exemplary embodiment;

FIG. 8(c) is an operation timing chart of a propagation path information generating circuit according to the first exemplary embodiment;

FIG. 8(d) is an operation timing chart of a pulse decoding circuit according to the first exemplary embodiment;

FIG. 9(a) is a diagram showing a numerical value of each chip and the number of states of two pulse sequences which interfere with each other in a trellis state of a pulse decoding circuit according to the first exemplary embodiment;

FIG. 9(b) is a diagram showing trellis state transition having four states made using a chip value where two pulse sequences in a trellis state of a pulse decoding circuit overlap with each other temporally according to the first exemplary embodiment;

FIG. 10, a flow chart illustrating a procedure of a pulse decoding circuit and a data decoding circuit according to the first exemplary embodiment;

FIG. 11 is a diagram showing a pulse on-off value and a data decoding result which are pulse decoding results in pulse sequences U1 and U2 according to the first exemplary embodiment;

FIG. 12(a) is a diagram exemplifying an extension method of a multiple value pulse position modulation method when transmitting 1 bit by 1 chip in a bit period according to the first exemplary embodiment;

FIG. 12(b) is a diagram exemplifying an extension method of a multiple value pulse position modulation method when transmitting 2 bits by 1 chip in a bit period according to the first exemplary embodiment;

FIG. 12(c) is a diagram exemplifying an extension method of a multiple value pulse position modulation method when transmitting 3 bits by 1 chip in a bit period according to the first exemplary embodiment;

FIG. 13 is a block diagram of a system using a plurality of receiving stations according to a second embodiment;

FIG. 14 is a block diagram of a central processing station according to the second embodiment; and

FIG. 15 is a flow chart showing a processing procedure of a central processing station according to the second embodiment.

### EXEMPLARY EMBODIMENT

The present invention relates to a receiving apparatus and a receiving method having a feature in a decoding method of a received signal when interference occurs between signals in an environment in which a plurality of transmission sources transmit pulse sequence signals by a random access method using a pulse position modulation method.

For this reason, in the present invention, using propagation path information obtained by performing synchronous detection to a received signal, a replica of a received pulse sequence signal is created. At the same time, a pulse sequence transmitted from each transmission source is regarded as a pulse string by on-off keying, and trellis state transition which takes an on-off value of a pulse string of each transmission source as a state is considered. Then, making a square error between a replica of a received signal and a measured value of a received signal is a metric, presumption of a pulse string is performed using the technique of maximum likelihood sequence estimation, and information from each transmission source is decoded simultaneously.

### The First Exemplary Embodiment

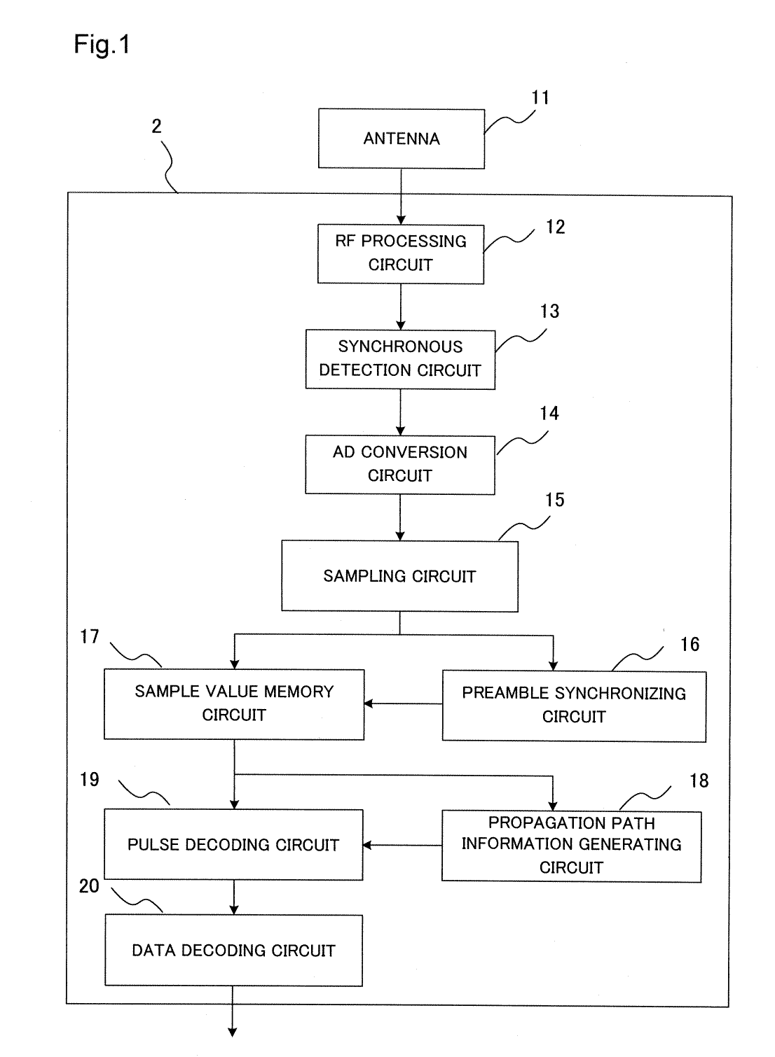

The first exemplary embodiment of the present invention will be described. FIG. 1 is a block diagram of a receiving apparatus according to the first exemplary embodiment of the present invention. A receiving apparatus 2 includes a RF processing circuit 12, a synchronous detection circuit 13, an AD conversion circuit 14, a sampling circuit 15, a preamble synchronizing circuit 16, a sample value memory circuit 17, a propagation path information generating circuit 18, a pulse decoding circuit 19 and a data decoding circuit 20. A pulse sequence from a transmission source is received by an antenna 11 and processed by the receiving apparatus 2.

The RF processing circuit 12 performs processing such as amplification, down conversion and band limiting filtering of a signal received by the antenna 11. The synchronous detection circuit 13 outputs a complex signal (IQ signal) obtained by performing synchronous detection of the received signal. To the AD conversion circuit 14, the signal from the synchronous detection circuit 13 is inputted. Then, the AD conversion circuit 14 samples this signal with a fast frequency (hereinafter, referred to as AD timing), and outputs the sampled signal as a sample value.

The sample value from the AD conversion circuit 14 is inputted to the sampling circuit 15. Then, the sampling circuit 15 generates sampling timing (hereinafter, referred to as pulse timing) which is timing for determining on-off of a pulse, and outputs the sample value at this pulse timing.

The sample value from the sampling circuit 15 is inputted to the preamble synchronizing circuit 16. The preamble synchronizing circuit 16 takes correlation with a known pulse string preamble. After that, the preamble synchronizing circuit 16 establishes synchronization of the pulse sequence (a packet including a preamble and data by a string of pulses) by monitoring an absolute value or a square value of the obtained correlation value, and outputs start timing of a pulse sequence.

To the sample value memory circuit 17, the sample value is inputted from the sampling circuit 15 and the start timing is inputted from the preamble synchronizing circuit 16. Then, the sample value memory circuit 17 outputs the sample value and the start timing based on the start timing.

To the propagation path information generating circuit 18, the sample value and the start timing is inputted from the sampling circuit 15. The propagation path information generating circuit 18 generates and outputs propagation path information which is a carrier wave amplitude and a phase of a pulse.

To the pulse decoding circuit 19, the sample value is inputted from the sampling circuit 15, and propagation path information is inputted from the propagation path information generating circuit 18. The pulse decoding circuit 19 performs pulse decoding of a received signal and outputs a pulse string as a pulse decoding result.

Using the pulse decoding result from the pulse decoding circuit 19 as an input, the data decoding circuit 20 decodes the data transmitted by a pulse position modulation, and outputs the result.

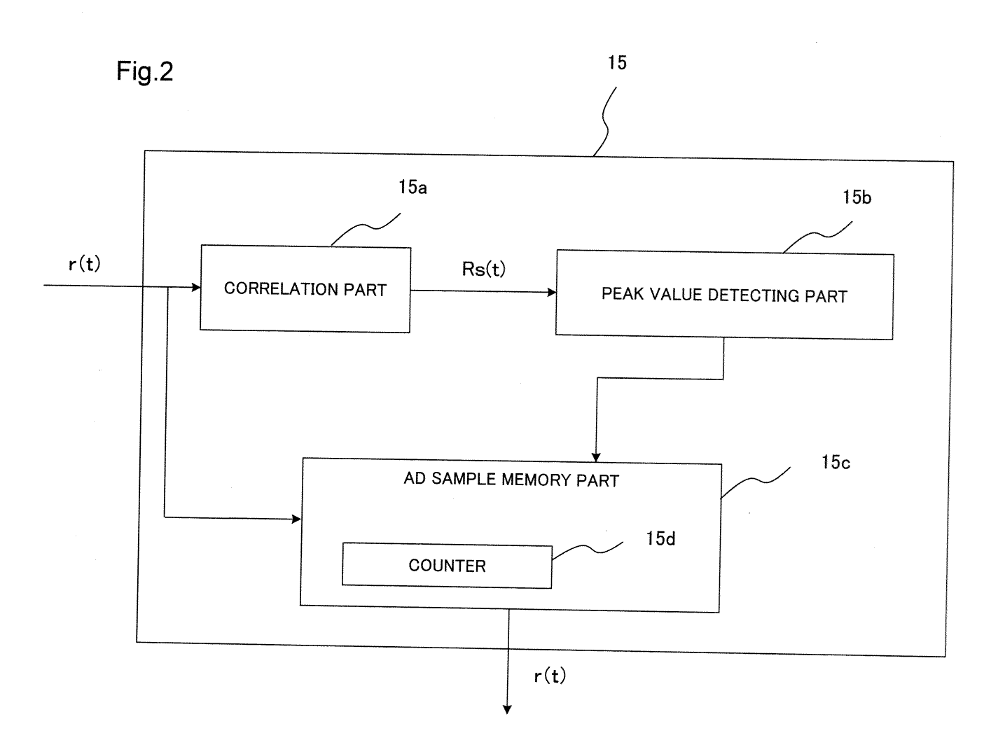

Next, a detailed structure of the sampling circuit 15 will be described. FIG. 2 is a block diagram of the sampling circuit 15. The sampling circuit 15 includes a correlation part 15a, a peak value detecting part 15b, an AD sample memory part 15c having a counter 15d.

The correlation part 15a calculates a correlation value Rₛ (t) between a sample value r (t) of a complex number inputted from the AD conversion circuit 14 at AD timing and a known waveform value signal (a₀, a₁ . . . , a_{Ns-1}) of a complex number according to Formula 1. Meanwhile, the known waveform value signal (a₀, a₁ . . . , a_{Ns-1}) is a signal obtained by sampling a known pulse waveform signal set in advance at AD timing.

$$Rs ( t ) = {\sum }_{i = 0}^{Ns} ( {a}_{i} \cdot {r}^{*} ( i - t ) ) \qquad ( 1 )$$

Here, Ns is an integer determined by a sampling frequency of the AD conversion circuit 14 and a duration of a single pulse. Also, r* (t) indicates the complex conjugate of sample value r (t). Hereinafter, when a complex conjugate is indicated, it is indicated by the superscript “*” similarly. This correlation value Rₛ (t) is outputted to the peak value detecting part 15b.

The peak value detecting part 15b monitors the square value or the absolute value of the output value from the correlation part 15a. Then, at the time when the peak value is detected, the peak value detecting part 15b outputs a timing signal.

The AD sample memory part 15c stores the sample value r (t) inputted from the AD conversion circuit 14 at AD timing. When the timing signal is inputted from the peak value detecting part 15b, the AD sample memory part 15c outputs the sample value r (t) corresponding to pulse timing based on this timing signal.

On this occasion, the AD sample memory part 15c uses only the first pulse of the pulse sequence as a timing signal from the peak value detecting part 15b. After that, sample value r (t) at pulse timing for which such as a pulse duration and a pulse transmission interval have been specified in advance is outputted using the inner counter 15d.

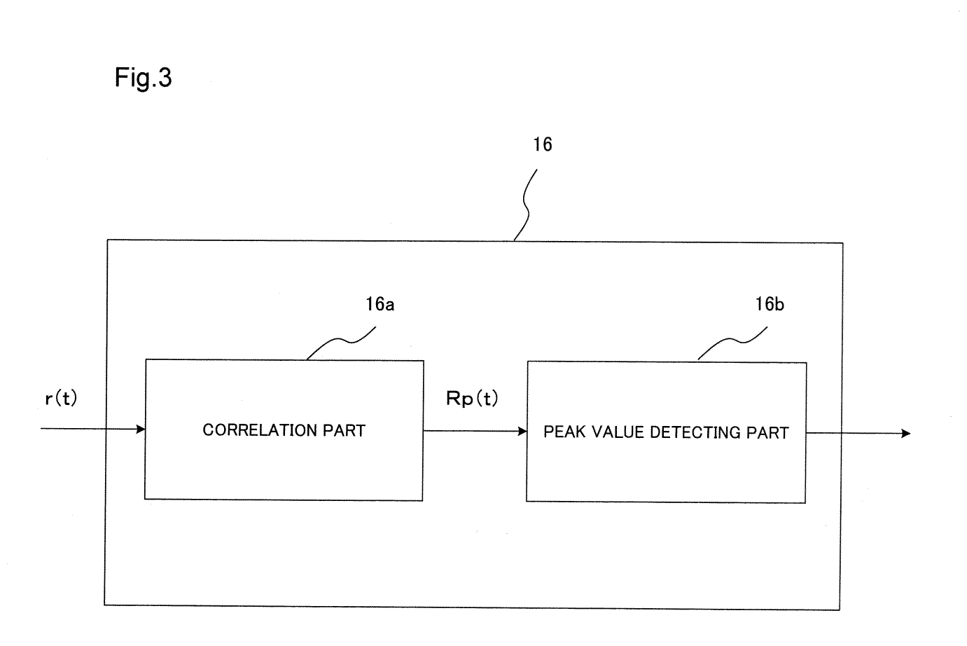

Next, the preamble synchronizing circuit 16 will be described. FIG. 3 is a block diagram of the preamble synchronizing circuit 16. The preamble synchronizing circuit 16 includes a correlation part 16a and a peak value detecting part 16b.

To the correlation part 16a, sample value r (t) is inputted from the sampling circuit 15 for each piece of pulse timing. The correlation part 16a calculates correlation value Rₚ (t) between the sample value r (t) and a preamble sequence (P₀, P₁, . . . , P_{NP-1}) (a complex number) specified in advance according to Formula 2. Here, |Pᵢ|=0, 1 (i=0, 1 . . . , Np−1). Np shows the length of the preamble sequence.

$$Rp ( t ) = {\sum }_{i = 0}^{Np - 1} \{ ( 1 - 2 \cdot \vert {P}_{i} \cdot \frac{r * ( i - t )}{\vert r * ( i - t ) \vert} \vert \cdot ( 1 - 2 \cdot \vert {P}_{i} \vert ) \} \qquad ( 2 )$$

This Pᵢ indicates a complex number given by an equivalent low-frequency signal A_{inf0}·e^{jθ inf0} a pulse in which information is superposed on an amplitude of a pulse by on-off keying, and also information is superposed on the pulse by phase-shift keying when the pulse is in on-state. Hereinafter, about a pulse including not only a pulse of a preamble but also a pulse of a data part to which similar modulation has been performed, a value indicated by the form of this complex number is described as a symbol value of a pulse. A_{inf0} indicates on-off of a pulse by a numerical value of 1 or 0. θ^{inf0} indicates a phase shifting amount by information, and j shows the imaginary unit.

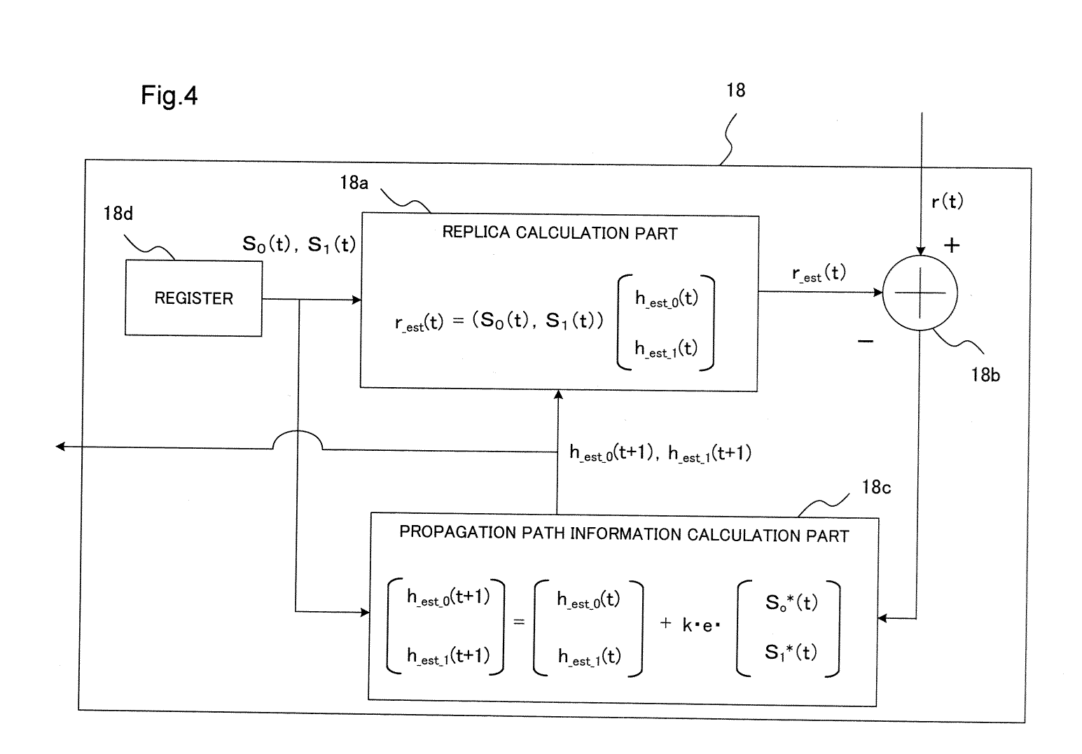

Next, the propagation path information generating circuit 18 will be described. FIG. 4 is a block diagram of the propagation path information generating circuit 18. The propagation path information generating circuit 18 includes a replica calculation part 18a, an error calculation part 18b, a propagation path information calculation part 18c and a register 18d. Meanwhile, this propagation path information generating circuit 18 will be described taking a case where it is configured based on a LMS (Least Mean Square) filter and pulse sequences from two transmission sources are interfering with each other as an example. Symbol values which transmission sources 0 and 1 transmit are described as S₀ (t) and S₁ (t). A propagation path information estimated value between the transmission sources 0, 1 and a receiving apparatus is described as h_{—}_{^{est}}_{—}_{⁰} (t) and h_{—}_{^{est}}_{—}_{¹} (t) (complex number), respectively.

Using a symbol value (here, a candidate value of a symbol value) S₀ (t), S₁ (t) of a pulse (here, |S₀(t)|=|S₁(t)|=0, 1) and propagation path information estimated values h_{—}_{^{est}}_{—}_{⁰} (t) and h_{—}_{^{est}}_{—}_{¹} (t) (complex number), the replica calculation part 18a calculates replica r_{—}_{^{est}} (t) of a received signal according to Formula 3. Indexes 0 and 1 attached to a symbol candidate value and a propagation path information estimated value indicate a transmission source.

$${r}_{\_est} ( t ) = ( {S}_{0} ( t ) , {S}_{1} ( t ) ) ( \begin{matrix}{h}_{\_est \_ 0} ( t ) \\ {h}_{\_est \_ 1} ( t )\end{matrix} ) \qquad ( 3 )$$

Meanwhile, as a numerical value of a candidate value S₀ (t) and S₁ (t), a known sequence is stored in the register 18d. In the error calculation part 18b, an error e between the sample value r (t) of a received signal inputted from the sampling circuit 15 and replica r_{—}_{^{est}} (t) of the received signal inputted from the replica calculation part 18a is calculated according to Formula 4.

e=r(t)−r_{—est}(t) (4)

The error e which is output from the error calculation part 18b, fixed number k which is a setting parameter, symbol candidate values of a pulse S₀* (t) and S₁* (t) are inputted to the propagation path information calculation part 18c.

Then, estimated values h_{—}_{^{est}}_{—}_{⁰} (t) and h_{—}_{^{est}}_{—}_{¹} (t) are calculated sequentially according to Formula 5.

$$( \begin{matrix}{h}_{\_est \_ 0} ( t + 1 ) \\ {h}_{\_est \_ 1} ( t + 1 )\end{matrix} ) = ( \begin{matrix}{h}_{\_est \_ 0} ( t ) \\ {h}_{\_est \_ 1} ( t )\end{matrix} ) + k \cdot e \cdot ( \begin{matrix}{S}_{0} * ( t ) \\ {S}_{1} * ( t )\end{matrix} ) \qquad ( 5 )$$

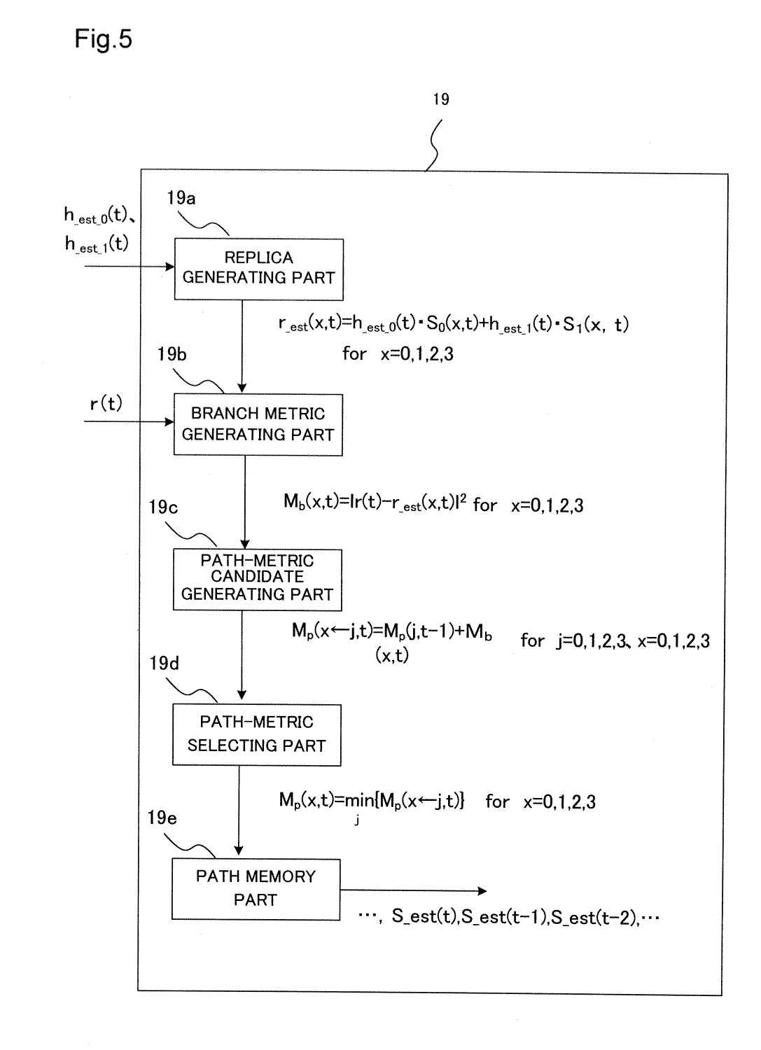

By the preamble synchronizing circuit 16, symbol reception time t of a preamble sequence from each transmission source is found. Accordingly, P₀, P₁, . . . , P_{NP-1} which are symbol values of the preamble sequence are inputted to S₀ (t) and S₁ (t) at each timing while synchronizing with sample value r (t) of the received signal, and calculation of propagation path information is carried out until the preamble sequence ends. Next, the pulse decoding circuit 19 will be described. FIG. 5 is a block diagram of the pulse decoding circuit 19. The pulse decoding circuit 19 includes a replica generating part 19a, a branch metric generating part 19b, a path-metric candidate generating part 19c, a path-metric selecting part 19d and a path memory part 19e.

The pulse decoding circuit 19 is configured based on Maximum-Likelihood Sequence Estimation (MLSE). Pulse strings transmitted from two transmission sources are decoded based on a maximum-likelihood path which has been identified by Viterbi algorithm from trellis state transition in which numerical values of symbol candidate values S₀ (t) and S₁ (t) of pulses transmitted from two transmission sources are used as a state.

The number of states of a trellis state transition diagram is determined by the biggest number of information bits that can be transmitted by one pulse. For example, when BPSK modulation is superposed on an on-state pulse in addition to on-off keying, because the number of information bits becomes 2 bits per one pulse, each of symbol candidate values S₀ (t) and S₁ (t) will have four states of {00, 01, 10, 11}.

Accordingly, when respective states of two transmission sources are considered, the number of states of a trellis state transition diagram will be 4×4=16 states. Hereinafter, in order to make description simple, it is supposed that only information by on-off keying is superposed on a pulse (S₀ (t) and S₁ (t) take a value of 0 and 1 respectively), and thus the number of states of a trellis state transition diagram is 2×2=4.

For pulse values S₀ (x, t) and S₁ (x, t) in state x on which attention is focused (S₀ (t) S₁ (t)={00, 01, 10, 11}), estimated value h_{—}_{^{est}}_{—}_{⁰} (t) and h_{—}_{^{est}}_{—}_{¹} (t) from the propagation path information generating circuit 18 are inputted to the replica generating part 19a. Then, replica r_{—}_{^{est}} (x, t) of the sample value r (t) is calculated according to Formula 6.

r_{—}_{^{est}}(x,t)=h_{—}_{^{est}}_{—}_{⁰}(t)·S₀(x,t)+h_{—}_{^{est}}_{—}_{¹}(t)·S₁(x,t) (6
for x=0, 1, 2, 3

The branch metric generating part 19b calculates a branch metric that corresponds to a square error according to Formula 7 using the sample value r (t) of the received signal and the replica r_{—}_{^{est}} (x, t).

M_{b}(x,t)=|r(t)−r_{—}_{^{est}}(x,t)|² (7)
for x=0, 1, 2, 3

The path-metric candidate generating part 19c performs processing corresponding to ADD among ACS (ADD, COMPARE and SELECT) of Viterbi algorithm, and generates a candidate for a path-metric according to Formula 8.

Mₚ(x←j,t)=Mₚ(j,t−1)+M_{b}(x,t) (8)
for j=0, 1, 2, 3, x=0, 1, 2, 3

The path-metric selecting part 19d performs a processing corresponding to COMPARE and SELECT according to Formula 9, compares a plurality of candidates for the path-metric, and selects one path-metric having the smallest numerical value.

Mₚ(x,t)=min{Mₚ(x←j,t)} (9)
for x=0, 1, 2, 3

The path memory part 19e stores, about each state x at time t, the state at the one-time-point-earlier time point, and, also, outputs S_{—}_{^{est}} (t) as a pulse decoding result at timing of the final time of the pulse string of interest.

Hereinafter, an operation in an exemplary embodiment of the present invention will be described using a format of Secondary Surveillance Radar (SSR) for air traffic control mode S in which a pulse position modulation method is used.

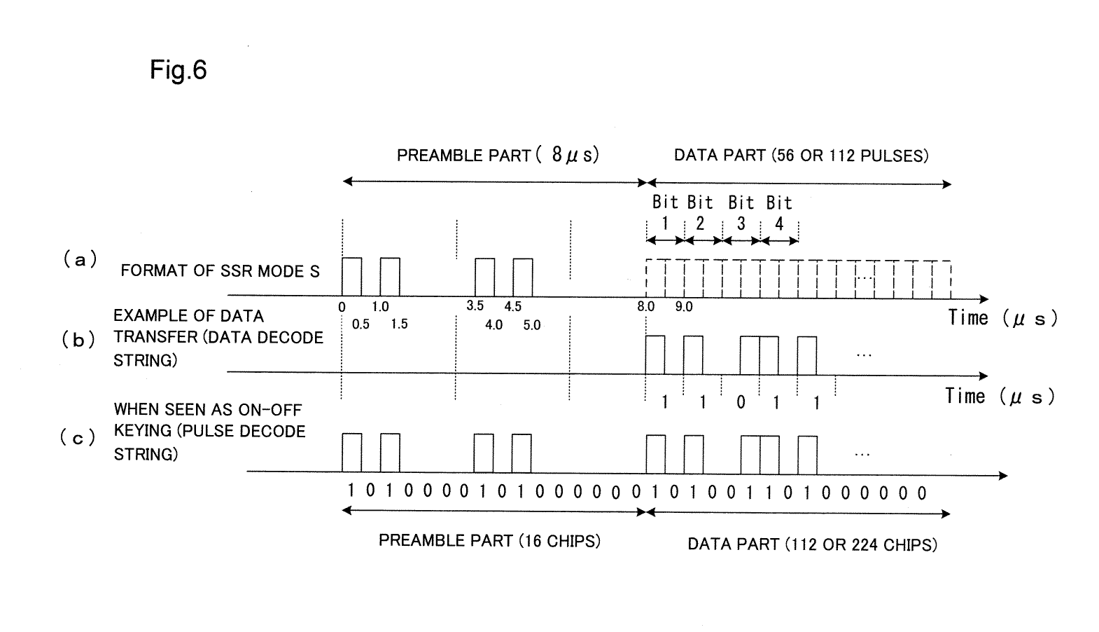

FIG. 6(a) is a timing chart of a format of the SSR mode S, FIG. 6(b) is a timing chart of a data decode string as an example of data transfer and FIG. 6(c) is a timing chart of a pulse decode string when seen as on-off keying.

As shown in FIG. 6(a), a pulse string of the SSR mode S is divided into a preamble part and a data part. In the preamble part, four pulses of a duration of 0.5 microseconds (henceforth, it is indicated as μs) are transmitted in a time interval shown in FIG. 6(a). After the fourth pulse and from the time point 8 μs, the data part according to pulse position modulation method starts. As shown in FIG. 6(b), although a 0.5 μs pulse is also used in the data part, by dividing 1 μs of the Bit time interval into halves, a pulse is transmitted in the first half of 0.5 μs when transmitting an information bit 1, and in the second half of 0.5 μs when transmitting an information bit 0.

In both of the data part and the preamble part, the pulse duration and the pulse transmission intervals are a multiple of 0.5 μs, and when seen from a different point of view, this pulse transmission sequence can be considered as on-off keying of 0.5 μs. Regarding the number of chips (hereinafter, the term “chip” is used for distinction from “bit” in pulse position modulation) in this case, the preamble part has 16 chips, the data part has 112 chips (in the case of 56 pulses), totaling 128 chips, as shown in FIG. 6(c).

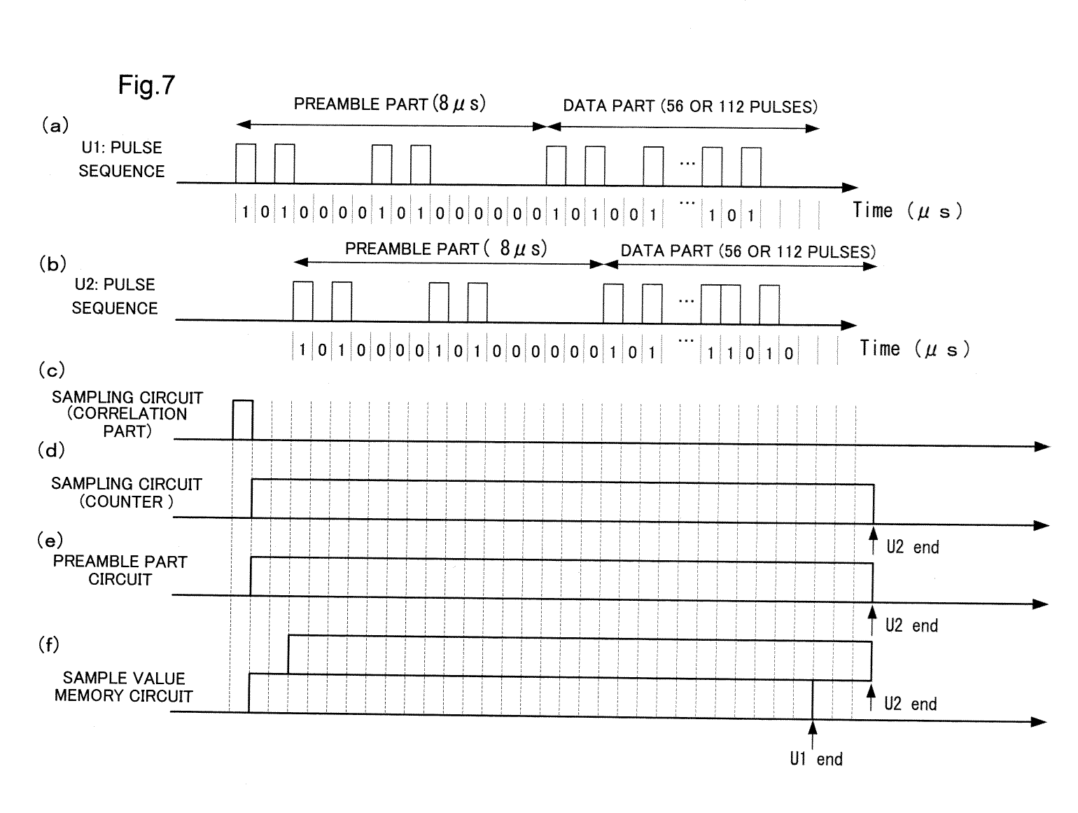

In bellow, description will be made taking a case where pulse sequences U1 and U2 from two transmission sources interfere with each other as an example. FIG. 7(a) and FIG. 7(b) indicate a timing chart of pulse sequences U1 and U2, and the pulse sequence U2 has arrived 3-chips time after the pulse sequence U1. FIGS. 7(c)-7(f) are diagrams which illustrate start timing of the correlation part 15a and the counter 15d of the sampling circuit 15, the preamble synchronizing circuit 16 and the sample value memory circuit 17 when decoding data in pulse sequences U1 and U2.

The first chip of the pulse sequence U1 is detected by the correlation part 15a of the sampling circuit 15, and, further, its pulse timing is identified. After that, the sampling circuit 15 calculates timing (pulse timing) of the second chip and later of the pulse sequence U1 using the counter 15d. Then, for each piece of pulse timing, sample value r (t) of a received signal corresponding to the relevant timing time t is outputted. These are inputted to the preamble synchronizing circuit 16 and the sample value memory circuit 17.

In the preamble synchronizing circuit 16, a correlation value between the received signal r (t) and the preamble is calculated, and the absolute value or the square value of the peak value of the correlation value is monitored. The preamble synchronizing circuit 16 keeps operation until data of the pulse sequence U2 ends, and detects start timing from another transmission source which has arisen during the operation period. The detected start timing is outputted to the sample value memory circuit 17.

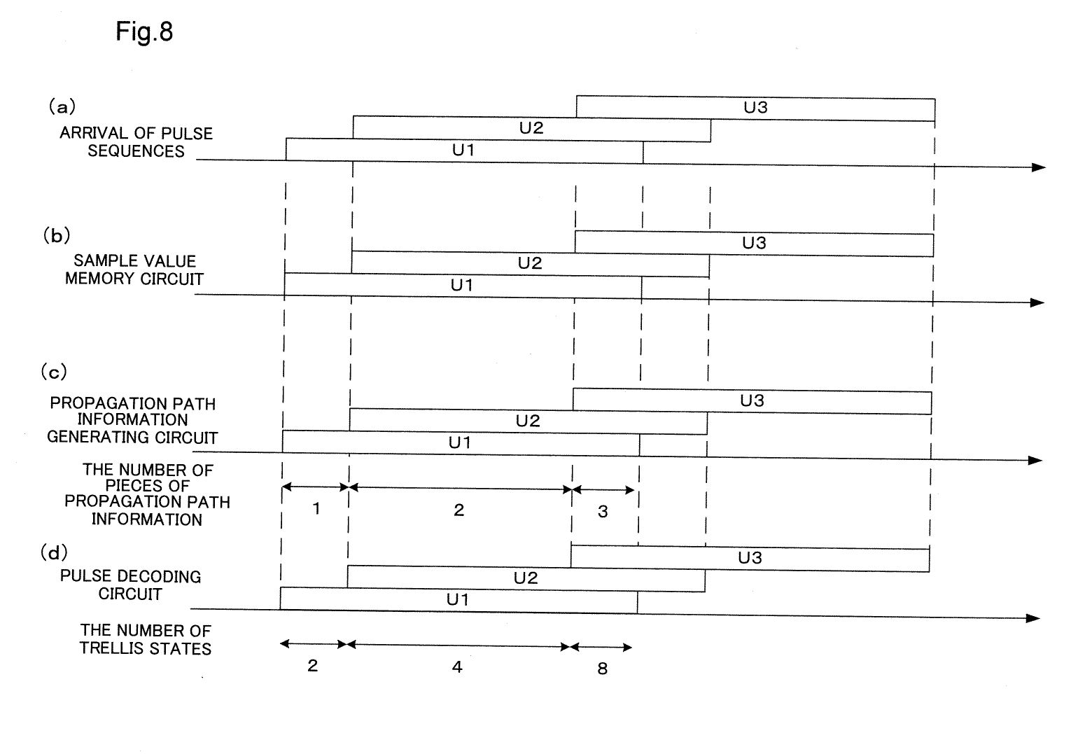

Taking the case where three pulse sequences U1, U2 and U3 has been received as an example, an operation of the propagation path information generating circuit 18, the pulse decoding circuit 19 and the data decoding circuit 20 will be described. FIG. 8(a) indicates arrival timing of three pulse sequences. FIG. 8(b) indicates operation timing of the sample value memory circuit 17, FIG. 8(c) of the propagation path information generating circuit 18 and FIG. 8(d) of the pulse decoding circuit 19.

FIG. 8(b) indicates an operation of the propagation path information generating circuit 18 and the pulse decoding circuit 19 when data of the pulse sequence U1, U2 and U3 is inputted to the sample value memory circuit 17. A pulse symbol value and start timing are inputted to the propagation path information generating circuit 18 in order of time, and propagation path information is generated. The Formula 5 above indicates a case where overlapping pulse sequences are two.

However, the number of pulse sequences changes to 1, 2 or 3 according to the way data from the pulse sequences U1, U2 and U3 overlap, and the number of pieces of the propagation path information also changes according to a change in the number of pulse sequences. For this reason, when the number of pieces of propagation path information changes, calculation is performed by changing the number of estimated value h. Meanwhile, processing after a pulse symbol value and data of start timing is inputted to the sample value memory circuit 17 does not have to be of real time.

After a propagation path information value is decided by the propagation path information generating circuit 18, the data decoding circuit 20 is started and pulse decoding for the preamble and later is begun. The number of Trellis states in a pulse decoder circuit changes to 2, 4 or 8 according to pulse sequences as shown in FIG. 8(b).

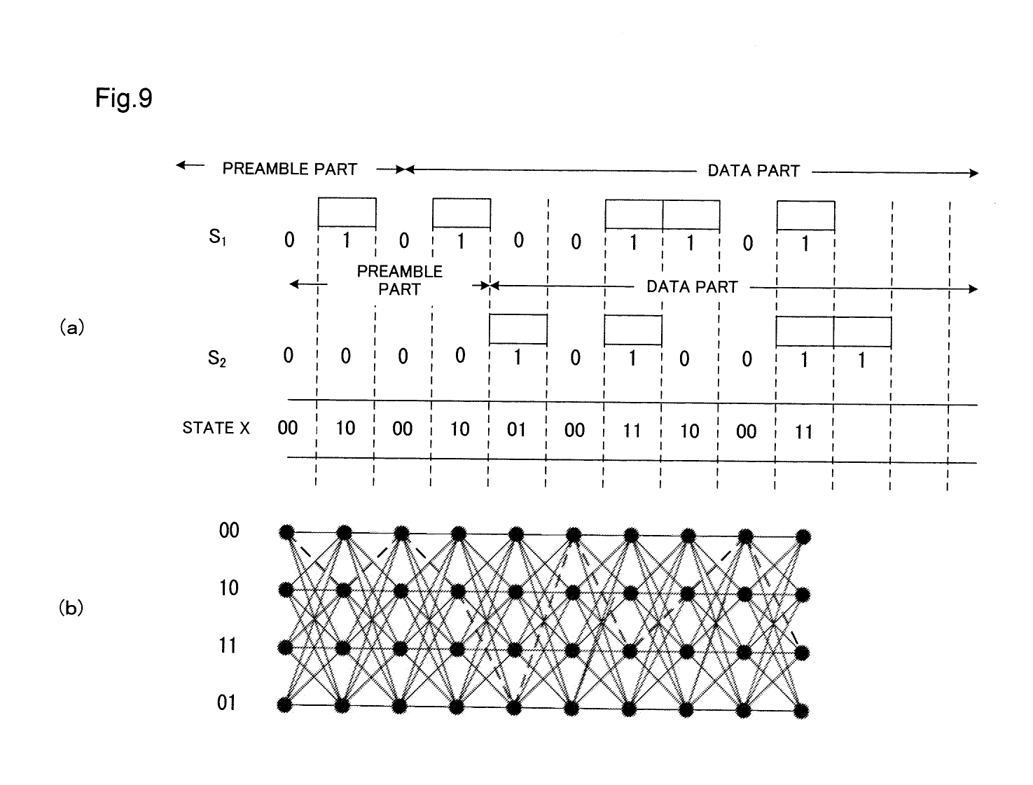

In order to describe an operation of the data decoding circuit 20, an example of each chip value of two pulse sequences which interfere with each other will be described regarding a case in which the number of states of state x (S₀S₁={00, 10, 11, 01}) is 4 with reference to FIG. 9. FIG. 9(a) indicates each chip value and states of two pulse sequences which interfere with each other. FIG. 9(b) indicates trellis state transition having four states made using chip values when two pulse sequences are overlapped timewise.

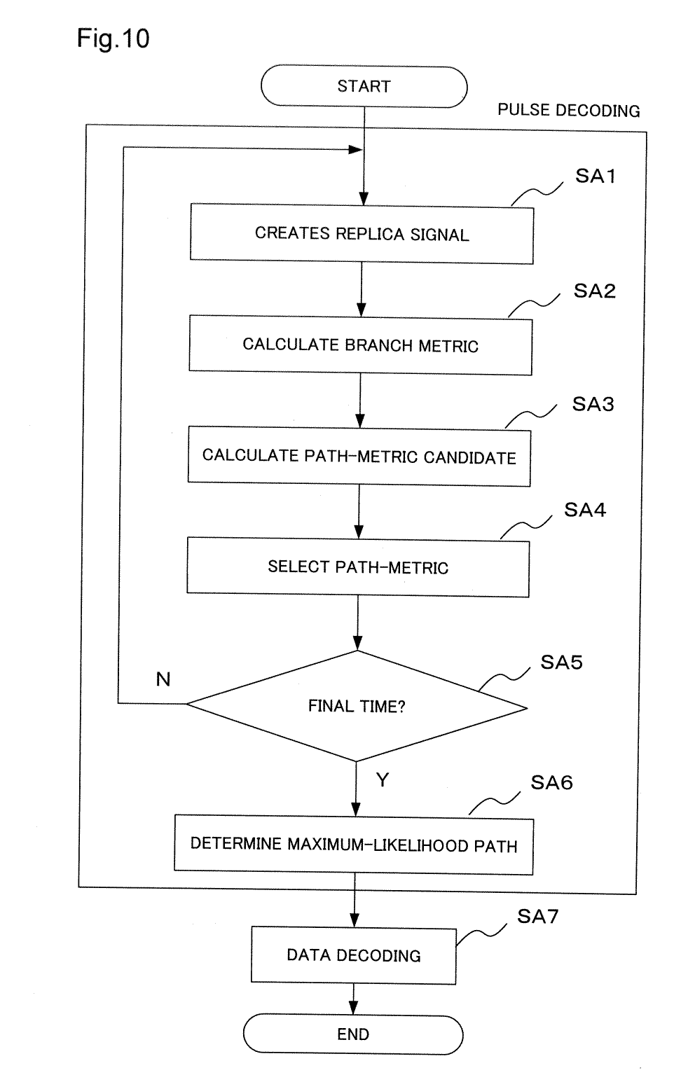

A maximum-likelihood path is presumed using Viterbi algorithm to this trellis, and pulse decoding of the pulse values is performed. The state transition of a thick dotted line in the state transition diagram indicates trellis state transition corresponding to the state shown in FIG. 9(a), and the object of Viterbi algorithm is to look for this thick dotted line from a lot of state transitions in the trellis. A procedure of a maximum likelihood sequence estimation based on Viterbi algorithm will be described with reference to the flow chart of FIG. 10.

Step SA1: The replica generating part 19a creates replica r_{—}_{^{est}} (x, t) of a received signal according to Formula 10 using a propagation path information value to each state x in time t.

r_{—}_{^{est}}(x,t)=h_{—}_{^{est}}_{—}_{⁰}·S₀(x,t)+h_{—}_{^{est}}_{—}_{¹}·S₁(x,t) (10)
for x=0, 1, 2, 3

Here, S₀ (x, t) and S₁ (x, t) indicate bit values (0 or 1) of the pulse sequences U1 and U2 respectively in state x at time t. Also here, propagation path information values h_{—}_{^{est}}_{—}_{⁰} and h_{—}_{^{est}}_{—}_{¹} of the pulse sequences U1 and U2 are fixed before data decoding, and time t is omitted in order to make these invariable until the end of the data.

Step SA2: For each state x in time t, the branch metric generating part 19b creates branch metric M_{b} (x, t) according to Formula 11 using replica r_{—}_{^{est}} (x, t) of a received signal created by the replica generating part 19a and the sample value r (t) of the received signal.

M_{b}(x,t)=|r(t)−r_{—}_{^{est}}(x,t)|² (11)
for x=0, 1, 2, 3

Step SA3: For each state x in time t, the path-metric candidate generating part 19c creates path-metric candidate Mₚ (x←j, t) for state x after state transition according to Formula 12 using path-metric Mₚ (j, t−1) at time t−1 that is one chip earlier. Here, j shows the state at t−1 before the transition.

Mₚ(x←j,t)=Mₚ(j,t−1)+M_{b}(x,t) (12)
for j=0, 1, 2, 3, x=0, 1, 2, 3

Step SA4: In each state x at time t, the path-metric selecting part 19d selects the minimum value from a plurality of Mₚ (x<-j, t) according to Formula 13, and outputs state j of the selected Mₚ (x<-j, t) to the path memory part 19e as path-metric Mp (x, t) at time t.

Mₚ(x,t)=min{Mₚ(x←j,t)} (13)
for x=0, 1, 2, 3

Step SA5: Then, time t is made be t=t+1 and whether t has reached the final time of the data or not is determined, and, when it is determined not reaching, the processing returns to step SA1.

Step SA6: At the final time t_{end} of the data, the path memory part 19e compares path-metric Mₚ (x, t_{end}) of four states of x, and selects a state having the minimum value. By tracking back clock time from a selected state and tracing states in the path memory, values of pulses are outputted in turn (it is called a tracing back). A path of state transition outputted by tracing until the beginning time of the data becomes the last selected path (maximum-likelihood path). A pulse value made by performing pulse decoding is outputted to a data decoding circuit.

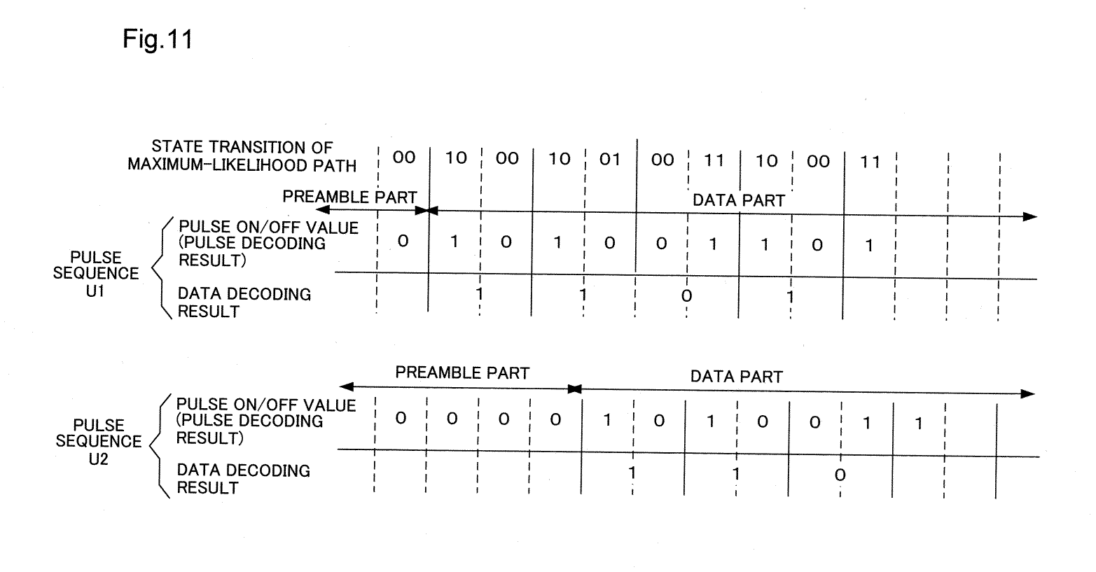

Step SA7: Data decoding of an information bit is performed to the pulse value inputted from the pulse decoding circuit. Relation between a pulse on-off value and a data decoding result of the pulse sequence U1 and U2 is shown in FIG. 11. As shown in FIG. 11, there is a case where bit time by the pulse position modulation method may not be identical between the pulse sequence U1 and U2. Data decoding of information bits of pulse sequences U1 and U2 is performed while caring about a difference in timing, and then processing is ended.

Further, because it is possible to presume the length of a pulse sequence by observing increase and decrease of path-metrics used in the maximum likelihood sequence estimation, decoding can be performed without regard to a difference in lengths of pulse sequences (when only the lengths of data parts are different).

Meanwhile, in the above description, although a case in which the number of overlaps of pulse sequences modulated by identical pulse position modulation is 2 and the number of information bits of one pulse is 1 has been indicated, extension is possible also to a case in which the number of overlaps is 3 or more by increasing the number of trellis states to 2TN according to the number of information bits in a pulse T and the number of overlaps N.

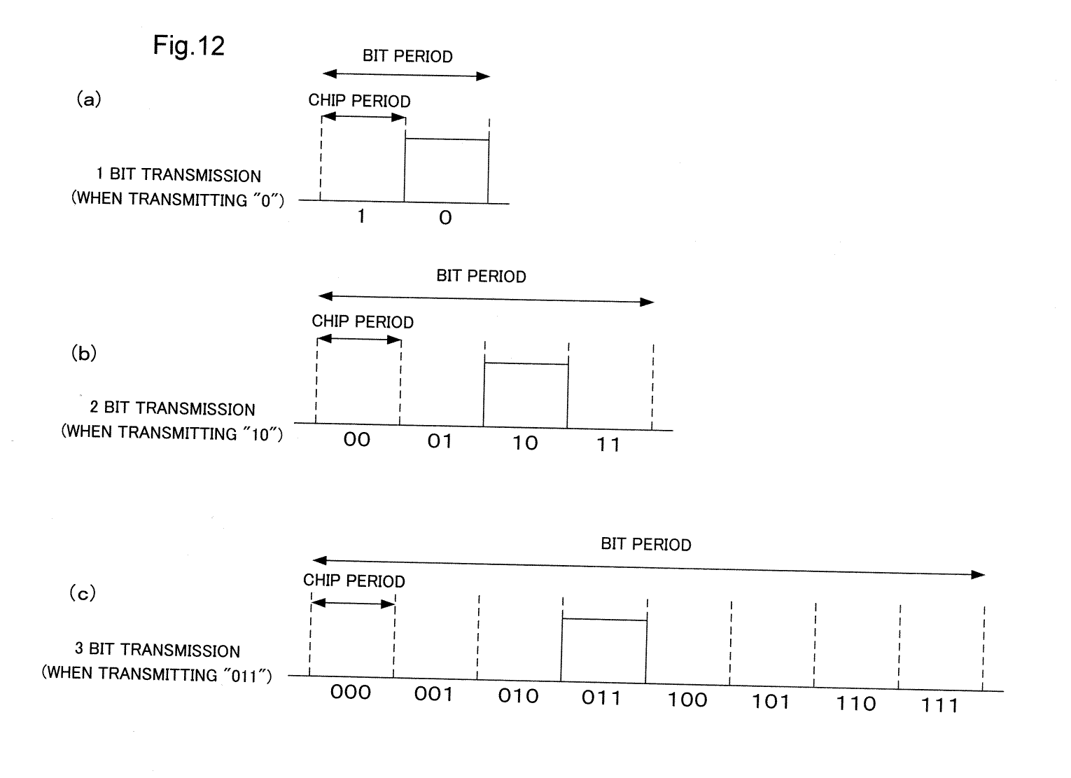

Although a case of two-valued pulse position modulation method has been indicated, it is possible to extend it to a case of a multiple value pulse position modulation method of a type to transmit a pulse by only one chip in a bit period as shown in FIG. 12(a)-(c). FIG. 12(a) shows a multiple value pulse position modulation method where one bit period is divides into two as described until now, FIG. 12(b) into four, FIG. 12(c) into eight. Even to such multiple value pulse position modulation methods, the method mentioned above can be applied.

### The Second Exemplary Embodiment

Next, the second exemplary embodiment of the present invention will be described. In a system using SSR mode S, there is a case where a plurality of receiving stations on the grounds are connected via a network, and each receiving station receives a pulse sequence from an airborne transponder. Meanwhile, in a description below, it is supposed that only on-off keying is performed for a pulse modulation.

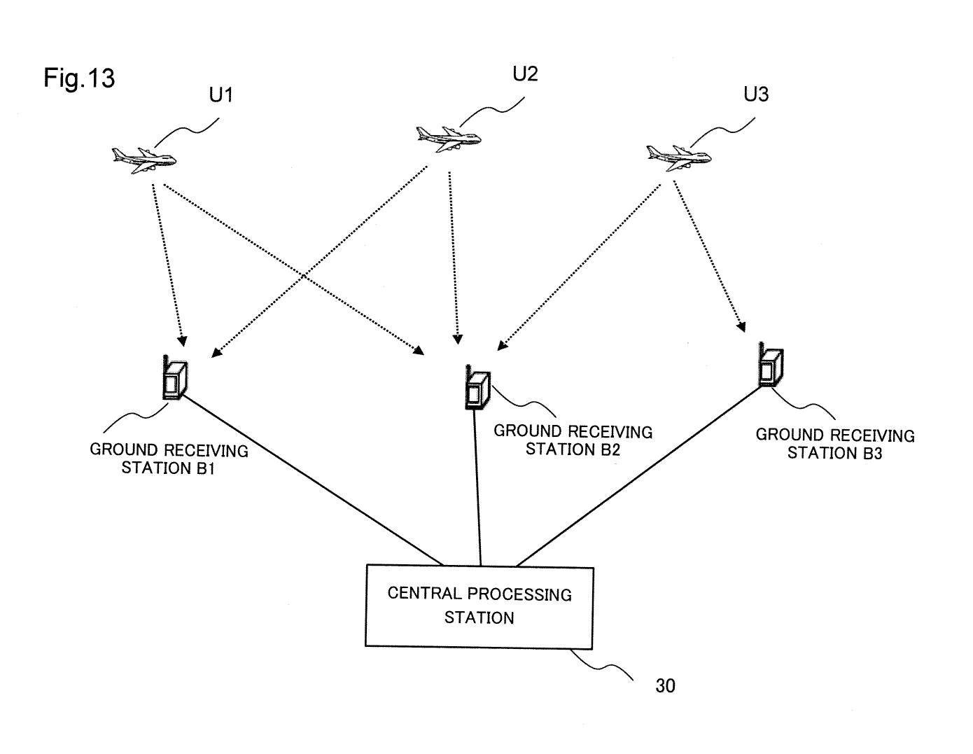

FIG. 13 is a diagram of a system using SSR mode S. Receiving stations B1-B3 receive a pulse sequence U1, pulse sequence U2 and pulse sequence U3 from airborne transponders transmitting a pulse sequence, and, further, a central processing station 30 collects information from each of the receiving stations B1-B3.

The receiving stations B1-B3 are equipped with the receiving apparatus 2 described in the first exemplary embodiment.

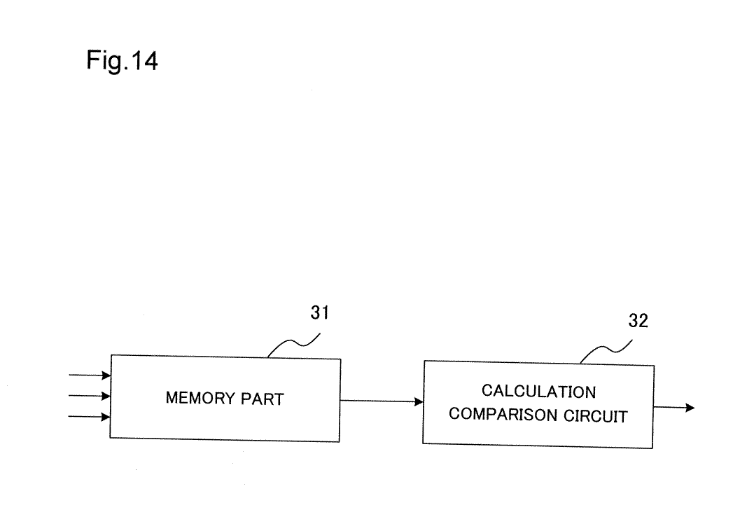

FIG. 14 is a block diagram of the central processing station 30. The central processing station 30 includes a memory part 31 and a calculation comparison circuit 32.

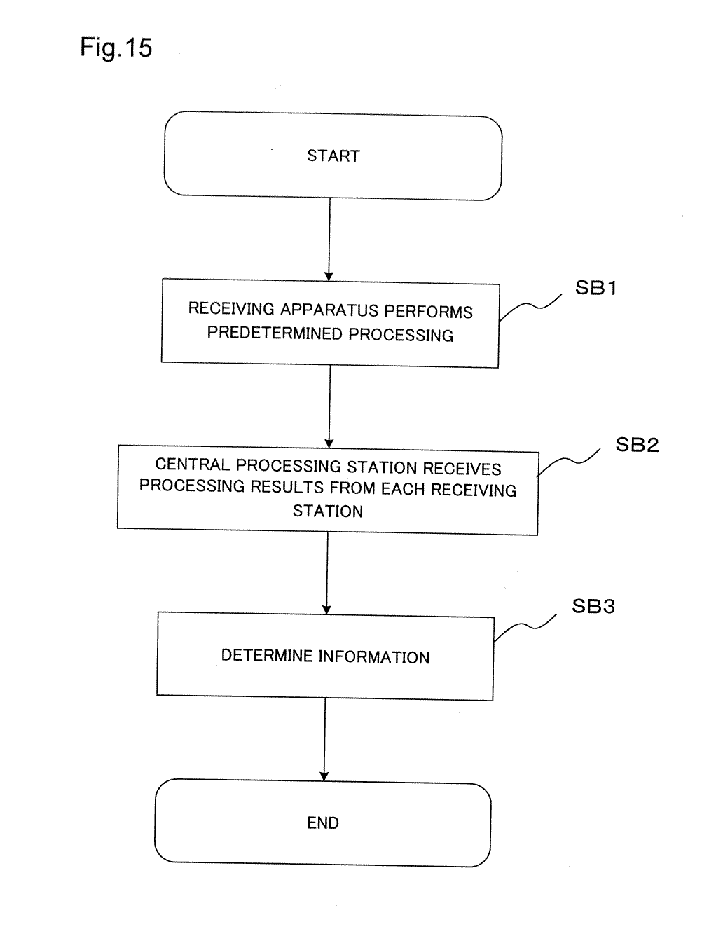

The memory part 31 stores information transmitted from each of the receiving stations B1-B3. The calculation comparison circuit 32 performs calculation and comparison using stored information, and outputs information transmitted by the transponders U1-U3. This central processing station 30 performs the following calculation and comparing processing. The processing will be described according to the flow chart shown in FIG. 15.

Step SB1: In the receiving apparatus 2 of the receiving stations B1-B3, processing of a received signal is performed.

As such processing, processing to output a pulse decoding result and processing to output a data decoding result can be illustrated.

Step SB2: The central processing station 30 receives processing results from the receiving stations B1-B3.

Step SB3: The central processing station 30 determines transmission information of the pulse sequence U1, the pulse sequence U2 and the pulse sequence U3 using the processing results from the receiving stations B1-B3. As an example of a determination method of such transmission information, when a processing result from each of the receiving stations B1-B3 is of data decoding (bit value), there is a method to determine by majority vote of respective pieces of data decoding. When a processing result from each of the receiving stations B1-B3 is pulse decoding, there is a method to determine a bit value after taking a majority vote of pulse on-off values. Also, there is a method to obtain a result made by adding information indicating reliability to information from each of the receiving stations B1-B3 using a reception level at each of the receiving stations B1-B3 or a ratio of a desired signal vs. an interfering signal (S/I).

It is supposed that a decoded value for a pulse on-off value that the pulse sequence U1 has transmitted at time t=0 and t=1 are S_{U1} (0) and S_{U1} (1), and one bit D1 is constituted by these two pulses. It is also supposed that the final results decoded by the central processing station 30 are S_{—}_{^{est}}_{—}_{^{U1}} (0) and S_{—}_{^{est}}_{—}_{^{U1}} (1). It is further supposed that a processing result (decoding result) from each of the receiving stations B1-B3 as shown in Table 1 has been collected by the central processing station 30.

| | PULSE ON-OFF | | | | |
|---|---|---|---|---|---|
| | VALUE (PULSE | | | | |
| | DECODING | | DATA DECODING | LEVEL OF THE | |
| RECEIVING | RESULT) | | RESULT | DESIRED WAVE | LEVEL OF THE |
| STATION | S_{U1}(0) | S_{U1}(1) | (BIT VALUE)D1 | SIGNAL h | INTERFERENCE I |
| B1 | 1 | 0 | 1 | h_{B1} | I_{B1} |
| B2 | 0 | 1 | 0 | h_{B2} | I_{B2} |
| B3 | 1 | 0 | 1 | h_{B3} | I_{B3} |

In this case, the central processing station 30 determines a value of bit D1 of a data decoding result using a majority voting method mentioned above by the following methods of (1)-(4). Of course, these methods are for illustration. Meanwhile, here, it is supposed that, about only a pulse on-off value from the receiving station B2, decoding has been failed and its value has been reversed.

(1) A case where a majority voting method is applied to a data decoding result from each of the receiving stations B1-B3

In this case, bit D1 is obtained by applying a majority voting function maj to a data decoding result (1, 0, 1) from each of the receiving stations B1-B3. In this case, because “1” is the majority, bit D1 will be: D1=maj (1, 0, 1)=1.

(2) A case where a majority voting method is applied to a pulse decoding result of a pulse on-off value from each of the receiving stations B1-B3

In this case, a processing result from each of the receiving stations B1-B3 is a pulse decoding result. The central processing station 30 applies the majority voting function to each pulse decoding result. It is supposed that results from this majority voting function are S_{U1} (0) and S_{U1} (1). In the case that pulse decoding results are (1, 0, 1) and (0, 1, 0), the results will be S_{U1} (0)=maj (1, 0, 1)=1 and S_{U1} (1)=maj (0, 1, 0)=0. Accordingly, bit D1 will be D1=1.

(3) A case where the level of the desired wave signal in the each of the receiving stations B1-B3 is considered

In this case, only a method using an on-off value of a pulse is used. About a pulse on-off value from each of the receiving stations B1-B3, M_{SU1 (0)} and M_{SU1 (1)} which are obtained by performing weighted addition in level h according to Formula 14 and Formula 15 are calculated.

$$\begin{matrix}{M}_{SU 1 ( 0 )} = \vert {h}_{B 1} \vert \cdot ( 2 \cdot {S}_{\_est \_ U 1 \_ B 1} ( 0 ) - 1 ) + \vert {h}_{B 2} \vert \cdot ( 2 \cdot {S}_{\_est \_ U 1 \_ B 2} ( 0 ) - 1 ) + \vert {h}_{B 3} \vert \cdot ( 2 \cdot {S}_{\_est \_ U 1 \_ B 3} ( 0 ) - 1 ) & ( 14 ) \\ {M}_{SU 1 ( 1 )} = \vert {h}_{B 1} \vert \cdot ( 2 \cdot {S}_{\_est \_ U 1 \_ B 1} ( 1 ) - 1 ) + \vert {h}_{B 2} \vert \cdot ( 2 \cdot {S}_{\_est \_ U 1 \_ B 2} ( 1 ) - 1 ) + \vert {h}_{B 3} \vert \cdot ( 2 \cdot {S}_{\_est \_ U 1 \_ B 3} ( 1 ) - 1 ) & ( 15 )\end{matrix}$$

Here, S_{—}_{^{est}}_{—}_{^{U1}}_{—}_{^{Bj}} (0) shows a pulse decoding result from receiving station Bj (j=1, 2, 3). When M_{SU1} (0) and M_{SU1} (1) is “0” or more, a pulse on-off value is made be “1”, and, when less than “0”, be “0”.

Next, according to values of M_{SU1} (0) and M_{SU1} (1), pulse on-off value S_{—}_{^{est}}_{—}_{^{U1}} (0) and S_{—}_{^{est}}_{—}_{^{U1}} (1) are determined. That is, it is determined such that S_{—}_{^{est}}_{—}_{^{U1}} (0)=1 when M_{SU1} (0)≧0, and S_{—}_{^{est}}_{—}_{^{U1}} (0)=0 when M_{SU1} (0)<0. Also, it is determined such that S_{—}_{^{est}}_{—}_{^{U1}} (1)=1 when M_{SU1(1)}≧0, and S_{—}_{^{est}}_{—}_{^{U1}} (1)=0 when M_{SU1} (1)<0.

Information bit D1 is determined from S_{—}_{^{est}}_{—}_{^{U1}} (0) and S_{—}_{^{est}}_{—}_{^{U1}} (1) determined in this way. That is, it is determined such that information bit D1 is “1” when (S_{—}_{^{est}}_{—}_{^{U1}} (0), S_{—}_{^{est}}_{—}_{^{U1}} (1))=(1, 0). Information bit D1 is determined as “0” when (S_{—}_{^{est}}_{—}_{^{U1}} (0), S_{—}_{^{est}}_{—}_{^{U1}} (1))=(0,1).

(4) A case where a ratio of a desired signal vs. an interfering signal I of each base station is considered

Level h about each receiving station in the method (3) above is substituted with following Formulas 9-11, and then the method of (3) is applied.

h_{B1}:=h_{B1}·(|h_{B1}|²/|I_{B1}|²) (16)

h_{B2}:=h_{B2}·(|h_{B2}|²/|I_{B2}|²) (17)

h_{B3}:=h_{B3}·(|h_{B3}|²/|I_{B3}|²) (18)

Here, it is supposed that “I” is a level value of the whole interfering signals relative to a desired signal at the each of the receiving stations B1-B3. Here, “:=” means to substitute the left side with a numerical value of the right side.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A receiving apparatus for receiving a pulse sequence signal, comprising:
a pulse decoding unit which determines, by observing, about a detection signal obtained by performing synchronous detection of a pulse sequence signal modulated by at least a pulse position modulation method, the pulse sequence signal as a pulse string transmitted by on-off keying, and applying a maximum likelihood sequence estimation method using trellis state transition defined by a time interval of the on-off keying and an on-off value concerned, an on-off value of the received pulse string; and
a data decoding unit which decode, about the pulse string, information data transmitted by the pulse position modulation method.

2. The receiving apparatus according to claim 1, further comprising:
a decryption processing unit which performs a decryption processing to the trellis state transition having the number of states of 2 raised to the Nth power, when receiving the pulse sequence signal transmitted from at least N transmission sources (N is an integer of no smaller than 1).

3. The receiving apparatus according to claim 1, wherein
the pulse sequence signal further comprises:
a correlation value calculation unit which calculates, when a preamble that is a known pulse string is included, a correlation value between the pulse sequence signal and a pulse string of the preamble; and
a timing calculation unit which calculates reception timing of the pulse sequence signal based on a peak value of the calculated correlation value; wherein
the pulse decoding unit determines an on-off value of the pulse string using the timing signal.

4. The receiving apparatus according to claim 1, wherein
the pulse decoding unit performs, when the received pulse sequence signal is a signal modulated by a pulse phase modulation method in addition to the pulse position modulation method, pulse decoding processing to trellis state transition defined by an on-off value of a pulse by a pulse position modulation and information by phase modulation using a complex symbol value defined by an on-off value of a pulse by a pulse position modulation and phase information by phase modulation to the pulse sequence signal.

5. The receiving apparatus according to claim 1, wherein
the pulse sequence signal including the preamble is a signal specified by Secondary Radar for air traffic control mode S.

6. A receiving method for receiving a pulse sequence signal, comprising:
a pulse decoding procedure for determining, by observing, about a detection signal obtained by performing synchronous detection of a pulse sequence signal modulated by at least a pulse position modulation method, the pulse sequence signal as a pulse string transmitted by on-off keying, and applying a maximum likelihood sequence estimation method using trellis state transition defined by a time interval of the on-off keying and an on-off value concerned, an on-off value of the received pulse string; and
a data decoding procedure for decoding, about the pulse string, information data transmitted by said pulse position modulation method.

7. The receiving method according to claim 6, further comprising:
a procedure to perform, when receiving the pulse sequence signal transmitted from at least N transmission sources (N is an integer of no smaller than 1), decryption processing to the trellis state transition having the number of states of 2 raised to the Nth power.

8. The receiving method according to claim 6, wherein
the pulse sequence signal further comprises:
a correlation value calculation procedure for calculating, when a preamble that is a known pulse string is included, a correlation value between the pulse sequence signal and a pulse string of the preamble; and
a timing calculation procedure for calculating reception timing of the pulse sequence signal based on a peak value of the correlation value that has been calculated; wherein
the pulse decoding procedure determines an on-off value of the pulse string using the timing signal.

9. The receiving method according to claim 6, wherein
the pulse decoding procedure performs, when the received pulse sequence signal is a signal modulated by a pulse phase modulation method in addition to the pulse position modulation method, pulse decoding processing to trellis state transition defined by an on-off value of a pulse by a pulse position modulation and information by phase modulation using a complex symbol value defined by an on-off value of a pulse by a pulse position modulation and phase information by phase modulation to the pulse sequence signal.

10. The receiving method according to claim 6, wherein
the pulse sequence signal including the preamble is a signal specified by Secondary Radar for air traffic control mode S.
